(19) United States
(12) Patent Application Publication
(10) Pub. No.: US 2013/0099923 A1
(43) Pub. Date: Apr. 25, 2013

(54) STEALTH TRACKING DEVICE

(71) Applicant: Wilfried E. Zschiedrich, Venice, FL (US)

(72) Inventor: Wilfried E. Zschiedrich, Venice, FL (US)

(21) Appl. No.: 13/676,314

(22) Filed: Nov. 14, 2012

(51) Int. Cl. G08B 13/24

(52) U.S. Cl. CPC G08B 13/2462
USPC 340/539.32

(57) ABSTRACT

A device to track and to provide positioning information for goods susceptible to be stolen, such as objects of value and vehicles, based on a undetectable module which can be activated by a motion-sensor, thereby allowing the disappeared goods to be located instantaneously and inconspicuously and, unperceived by the thief, transmitting the position of such goods to their owner.

### BACKGROUND

There are presently numerous mechanical and electronic systems and devices in existence for protection against theft. All these protective devices have a common purpose to prevent theft and/or to detract from stealing. These are either factory-installed or retrofitted later-on, on an as-needed basis.

Such systems, for example, activate an alarm signal upon breaking-in into a vehicle or by activation of a thermal-, light- or vibration-sensor. That signal may then be visual, audio and/or transmitted to a predetermined party. Likewise, there are similar devices to protect a diversity of objects of value.

Also, GPS based locators are now common. These are generally temper-proof.

All these devices may act as a theft deterrent and/or as a locator of disappeared goods, but being detectable by scanners, they are vulnerable to be made inoperative.

### SUMMARY OF DESCRIPTION

The tracking device contains a normally armed, undetectable, miniature, self-sustaining electronic module, inconspicuously installed at an object or vehicle to be protected against theft. This device forms a complete system with a standard receiver/transmitter location on the owner's side.

Upon a preset motion of the goods, the module detects its physical location and wirelessly transmits that information to a remote owner. Thereafter, the device returns to an undetectable standby sleeping mode until re-activation either through further motion, or through the timer's setting or through wireless remote request by owner.

### SUMMARY OF DRAWINGS

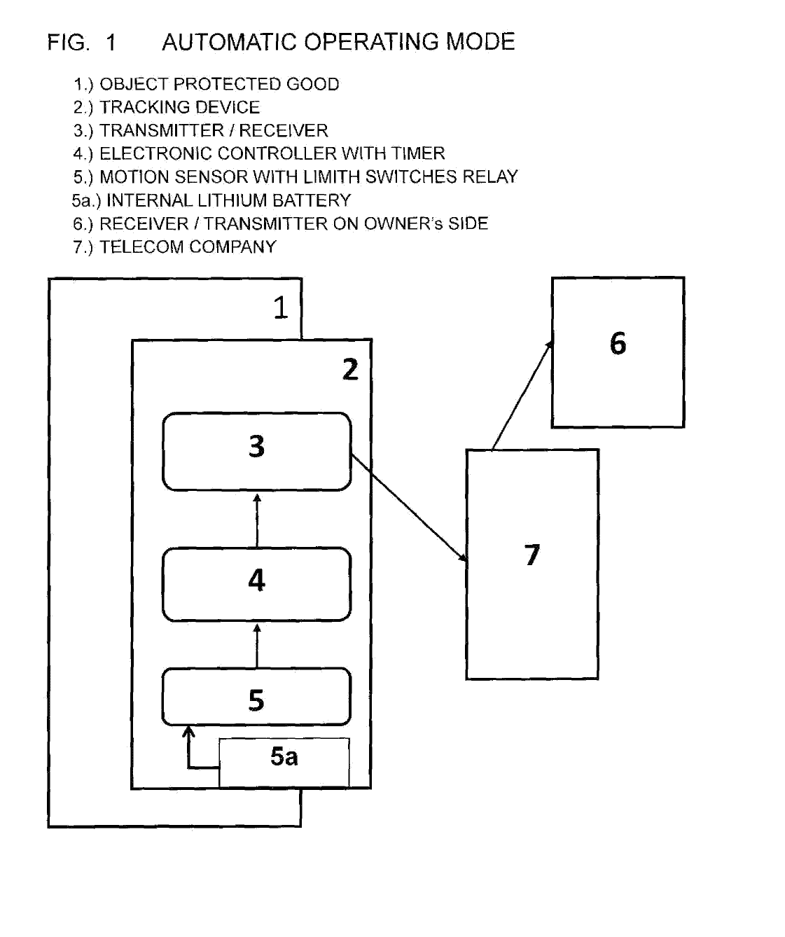

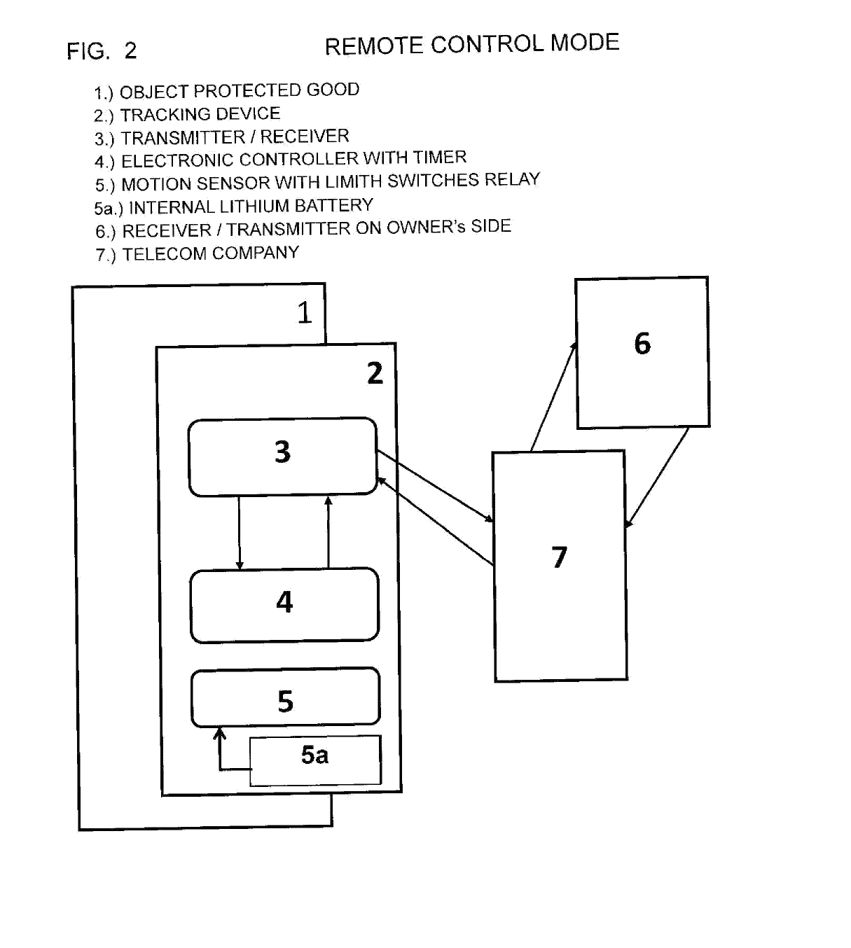

The drawings show the schematic flow arrangement of the tracking device's components, namely under the normal automatic operation mode in FIG. 1 and under the remote operation control mode in FIG. 2.

### DETAILED DESCRIPTION

The tracking device described below is installed in a vehicle and is normally armed/set on standby, during which the device is kept inactive, the power supply not being enabled. As such, the device remains undiscoverable by electronic scanners as well. Such a tracking device may, however, be installed on other objects of value as well, such as boats, planes, objects of arts, furniture, antiques etc.

The power supply of the tracking device is provided by its own low voltage, rechargeable Lithium battery (5a). Alternatively, if the protected good is a vehicle, the tracking device may be tied into an existing power supply, such as the battery of that vehicle. In latter case, if the vehicle's battery should be disconnected, the Lithium battery will still remain operational for a longer period of time.

Referring to FIG. 1 and FIG. 2, the tracking device is composed of two major elements: Located at the protected good, a miniature electronic module as a first element and a second element, namely a standard receiver/transmitter at the owner's location.

The above electronic module contains a motion-sensor (5), an electronic controller and timer (4) and a transmitter/receiver (3). This module is installed in a normally inaccessible location of the protected good (1), hidden from the view.

The motion-sensor (5) works on inertia and is pre-programmed as to a motion limit of the good. When these limits are exceeded, an electronic impulse activates the controller (4), whereby a relay keeps the controller under power.

The electronic controller (4) is pre-programmed with the following information: Day, time, location (GPS coordinates and address), owner's nature of the property (at owner's option, such as car type and registration), owner's phone number and PIN number requirements. In addition, it may be set to control repeated transmittals regular time intervals, while it goes into an undetectable standby sleeping mode between these intervals.

The further transmitter/receiver (6), required on the owner's side, is as part of the fully functional system. For this item, many options are open to the owner, such as regular telephone, cellphone, wireless devices, provided they are set on the same frequencies as the module's transmitter/receiver (3).

The present description is based on cellphone transmittals, which requires a third party provider (7), in this case a telephone company. Alternatively, other transmittal systems may be used without a provider, such as APRS, UHF or VHF etc., provided the module is correspondingly programmed.

### DETAILED DRAWINGS DESCRIPTION

FIG. 1 illustrates the case of a break-in or a tow-away theft. The motion-sensor (5) enables the power supply to the controller (4). At that point, the controller activates its locator and the pre-stored data, transmits this information to transmitter/receiver (3) which in turn, through the provider (7), sends it to the owner's receiver (6).

The owner may now initiate actions to recover the goods as promptly as possible.

FIG. 2 illustrated a remote control mode of the same tracking device. The request for tracking is initiated by the owner through his transmitter/receiver (6), going through the provider (7) to the transmitter/receiver (3) after use of the appropriate PIN Number. At that point, the transmitter (3) activates the electronic controller (4). The controller, after proper locating and processing, returns the required information in the usual form, going from item (4) through (3), (7) and (6) to the owner. One, may note that in this remote control mode, the transmitter/receiver (3) must be in a prior standby mode.

### ILLUSTRATIONS

FIG. 1 shows a schematic of the tracking device operating in an automatic mode.

FIG. 2 shows the same tracking device in a remote control mode.

1. A tracking device for goods that are susceptible to disappear or get stolen, such as objects of arts and vehicles, inconspicuously mounted, sensor activated, allowing for instantaneous theft identification, simultaneously locating the goods and transmitting the corresponding information to the appropriate owner,
characterized by
1. an electronically undetectable sensor being a linear motion-sensor set to a pre-set motion distance, beyond which an signal enables the power supply to a secured electronic controller with tracking capabilities, preferentially over GPS, and transmits at least the location of the disappeared goods to their owner, upon which the device goes into a standby sleeping mode until new re-activation, either due to further motion triggering, through the preset timer or through a remote command by the owner.
2. the electronic controller characterized by remote activation capabilities through the transmitter/receiver of the tracking device, secured by a PIN number.
3. the electronic un-detectability of the tracking device per claims 1 and 2, characterized by a normally disabled power supply, whereby scan-able electromagnetic emissions of the device are inexistent.
4. the motion-sensor per claims 1 to 3, characterized by inertia-activation.
5. the motion-sensor per claims 1 to 3, characterized by GPS-activation.
6. the electronic controller per claims 1 through 4 is characterized by all location functions and stored data transfers performed by the tracking device.
7. the electronic controller per claims 1 through 3 and 5, characterized by all location functions and stored data transfers performed by the tracking device.
8. the electronic controller per claims 1 through 3 and 5 characterized by a locator based on any common geographic capable data transmittal systems, such as but not limited to GSM, PPRS, HSCSD, EDGE, WIFI, VFR, UHF, APRS.
